(19) United States
(12) Patent Application Publication
(10) Pub. No.: US 2009/0043741 A1
(43) Pub. Date: Feb. 12, 2009

(54) Autocompletion and Automatic Input Method Correction for Partially Entered Search Query

(76) Inventor: Dohyung Kim, Seoul (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 12/188,163

(22) Filed: Aug. 7, 2008

Related U.S. Application Data
(60) Provisional application No. 60/954,898, filed on Aug. 9, 2007.

(51) Int. Cl. G06F 7/00; G06F 17/30

(52) U.S. Cl. 707/3; 707/100; 707/E17.066; 707/E17.032; 707/E17.108

(57) ABSTRACT

A method for processing query information includes receiving a partial search query from a search requestor, and obtaining a set of predicted complete queries corresponding to the partial search query from a plurality of previously submitted complete queries, the previously submitted complete queries submitted by a community of users. The set of predicted complete queries include both English language and Korean language complete search queries. The set of predicted complete queries are ordered in accordance with ranking criteria, and at least a subset of the ordered set is sent to the search requestor. The partial search query may be a Romanized representation of a partial Korean language search query.

### RELATED APPLICATIONS

This application claims priority under 35 U.S.C. 119 to U.S. Provisional Patent Application 60/954,898, filed Aug. 9, 2007, “Autocompletion and Automatic Input Method Correction for Partially Entered Search Query,” which is hereby incorporated by reference in its entirety.

This application is related to co-pending, commonly-assigned U.S. utility patent applications Ser. No. 10/987,295, “Method and System for Autocompletion Using Ranked Results,” filed on Nov. 11, 2004, and Ser. No. 10/987,769, “Method and System for Autocompletion for Languages Having Ideographs and Phonetic Characters,” filed on Nov. 12, 2004, the contents of which are incorporated by reference herein in their entireties.

### TECHNICAL FIELD

The disclosed embodiments relate generally to search engines for locating documents in a computer network (e.g., a distributed system of computer systems), and in particular, to a system and method for speeding up a desired search by anticipating a user's request.

### BACKGROUND

Search engines provide a powerful tool for locating documents in a large database of documents, such as the documents on the World Wide Web (WWW) or the documents stored on the computers of an Intranet. The documents are located in response to a search query submitted by a user. A search query may consist of one or more search terms.

In one approach to entering queries, the user enters the query by adding successive search terms until all search terms are entered. Once the user signals that all of the search terms of the query have been entered, the query is sent to the search engine. Embodiments of the present invention described below use another approach to entering queries. In this new approach, a partial query is transmitted to the search engine prior to a user indicating completion of the query. The search engine generates a list of predicted queries which is presented to the user. The user may select from the ordered list of predicted queries, or may continue entering a user specified query.

### SUMMARY

In accordance with some embodiments described below, a method for processing query information, performed at a server, includes receiving from a search requestor a partial search query, the search requestor located remotely from the server. The method further includes obtaining a set of predicted complete queries corresponding to the partial search query from a plurality of previously submitted complete queries, where the previously submitted complete queries were submitted by a community of users. The set of predicted complete queries include both first language and second language complete search queries. In addition, the method includes ordering the set of predicted complete queries in accordance with ranking criteria, and conveying at least a subset of the ordered set to the search requester.

In accordance with some embodiments, a method for processing query information, performed at a client, includes receiving from a search requester a partial search query. The method further includes obtaining a set of predicted complete queries corresponding to the partial search query from a plurality of previously submitted complete queries, where the previously submitted complete queries were submitted by a community of users. The set of predicted complete queries includes both first language and second language complete search queries and is ordered in accordance with ranking criteria. In addition, the method includes displaying at least a subset of the ordered set to the search requester.

In accordance with some embodiments, a method for building a data structure for processing query information includes obtaining a set of previously submitted complete first language queries, where the complete first language queries were previously submitted by a community of users. The method further includes obtaining a set of previously submitted complete second language queries, where the complete second language queries were previously submitted by a community of users. In addition, the method includes converting the set of complete first language queries into a set of complete first language queries in a representation using characters of the second language, and storing the sets of complete second language queries and converted complete first language queries in one or more query completion data tables. The one or more query completion data tables form one or more data structures capable of being used to predict both complete first language and second language queries corresponding to either partial first language queries or partial second language queries.

In some embodiments, a system for processing query information includes one or more central processing units for executing programs, and memory to store data and to store programs to be executed by the one or more central processing units. The programs include instructions for receiving from a search requestor a partial search query, the search requestor located remotely from the server. The programs further include instructions for obtaining a set of predicted complete queries corresponding to the partial search query from a plurality of previously submitted complete queries, where the previously submitted complete queries were submitted by a community of users. The set of predicted complete queries includes both first language and second language complete search queries. In addition, the programs further include instructions for ordering the set of predicted complete queries in accordance with ranking criteria, and conveying at least a subset of the ordered set to the search requester.

In some embodiments, a client system includes one or more central processing units for executing programs, and memory to store data and to store programs to be executed by the one or more central processing units, the programs including instructions for receiving from a search requestor a partial search query. The programs further include instructions for obtaining a set of predicted complete queries corresponding to the partial search query from a plurality of previously submitted complete queries, where the previously submitted complete queries were submitted by a community of users. The set of predicted complete queries includes both first language and second language complete search queries and is ordered in accordance with ranking criteria. In addition, the programs further include instructions for displaying at least a subset of the ordered set to the search requester.

In some embodiments, a computer readable-storage medium stores one or more programs for execution by one or more processors of a respective server system. The one or more programs include instructions for receiving from a search requester a partial search query, the search requestor located remotely from the server. The one or more programs further include instructions for obtaining a set of predicted complete queries corresponding to the partial search query from a plurality of previously submitted complete queries, the previously submitted complete queries submitted by a community of users. The set of predicted complete queries include both first language and second language complete search queries. In addition, the one or more programs include instructions for ordering the set of predicted complete queries in accordance with ranking criteria, and conveying a subset of the ordered set to the search requester.

In some embodiments, a computer readable-storage medium stores one or more programs for execution by one or more processors of a respective client device or system. The one or more programs include instructions for receiving from a search requester a partial search query. The one or more programs further includes instructions for obtaining a set of predicted complete queries corresponding to the partial search query from a plurality of previously submitted complete queries, the previously submitted complete queries submitted by a community of users. The set of predicted complete queries includes both first language and second language complete search queries and is ordered in accordance with ranking criteria. In addition, the one or more programs include instructions for displaying a subset of the ordered set to the search requestor.

The unified solution has particular application to Korean query predictions as it supports incomplete Korean character entry while automatically providing input method correction.

### BRIEF DESCRIPTION OF DRAWINGS

The aforementioned embodiment of the invention as well as additional embodiments will be more clearly understood as a result of the following detailed description of the various aspects of the invention when taken in conjunction with the drawings. Like reference numerals refer to corresponding parts throughout the several views of the drawings.

FIG. 1 is a block diagram of a search system in accordance with some embodiments.

FIG. 2 is a conceptual diagram that depicts a flows of information associated with creating and using data structures in accordance with some embodiments.

FIG. 3A is a flowchart of a method of processing of a partial query in accordance with some embodiments.

FIG. 3B is a flowchart of a process performed by a search assistant at a client system or device, in accordance with some embodiments.

FIGS. 4A and 4B depict character maps for conversion between Korean characters and a Romanized representation of the Korean characters.

FIG. 5 is a flowchart of a process for converting a string of Korean characters into a Romanized representation in accordance with some embodiments.

FIG. 6 depicts examples of predicted complete queries corresponding to an input string in accordance with some embodiments.

FIG. 7 depicts a process for processing historical queries in accordance with some embodiments.

FIG. 8 depicts partial search queries corresponding to two examples of complete search queries in a set of historical search queries in accordance with some embodiments.

FIG. 9 is a conceptual representation of a process for identifying a query completion table that corresponds to a received partial query, in accordance with some embodiments.

FIG. 10 depicts portions of two exemplary query completion tables in accordance with some embodiments.

FIG. 11 is a block diagram of a client system in accordance with some embodiments.

FIG. 12 is a block diagram of a server system in accordance with some embodiments.

FIG. 13 depicts a schematic screen shot of a web browser, a web page displayed in a web browser, or other user interface that lists English language and Korean language predicted complete queries corresponding to a user-provided partial query, in accordance with some embodiments.

### DESCRIPTION OF EMBODIMENTS

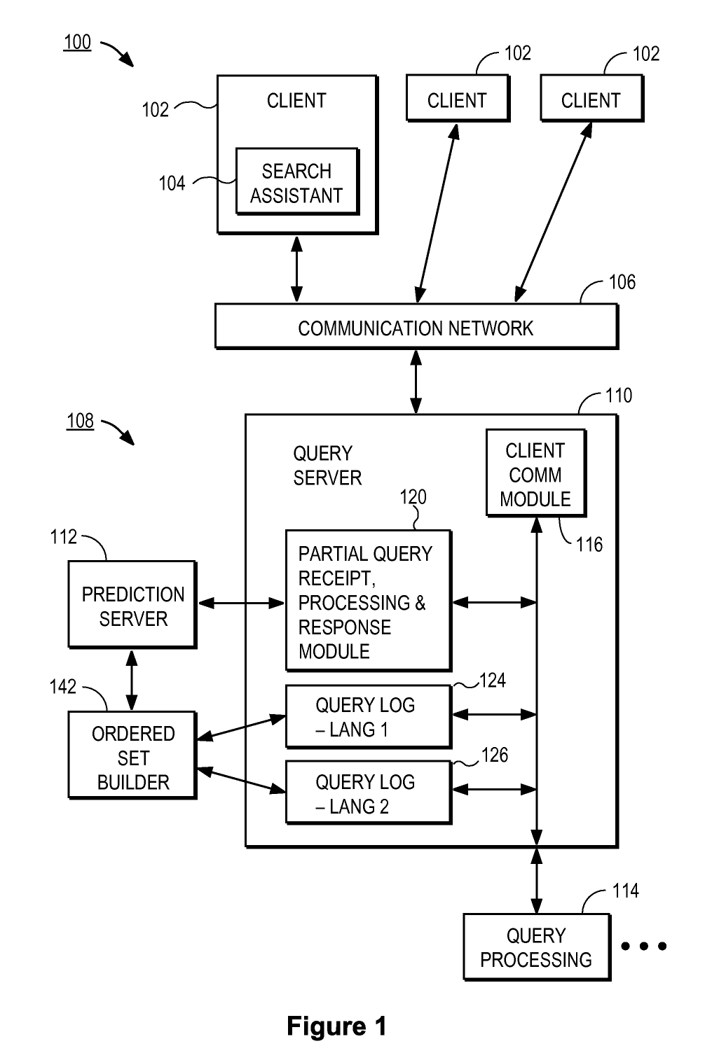

FIG. 1 illustrates a system 100, suitable for practice of embodiments of the invention. Additional details regarding the distributed system and its various functional components are provided in co-pending, commonly-assigned U.S. utility patent applications Ser. No. 10/987,295, “Method and System for Autocompletion Using Ranked Results,” filed on Nov. 11, 2004, and Ser. No. 10/987,769, “Method and System for Autocompletion for Languages Having Ideographs and Phonetic Characters,” filed on Nov. 12, 2004, the contents of which are incorporated by reference herein in their entireties. The system 100 may include one or more client systems or devices 102 that are located remotely from a search engine 108. A respective client system 102, sometimes called a client or client device, may be a desktop computer, laptop computer, kiosk, cell phone, personal digital assistant, or the like. A communication network 106 connects the client systems or devices 102 to the search engine 108. As a user (also called a search requester herein) inputs a query at a client system 102, the search assistant 104 transmits at least a portion of the user's partial query to the search engine 108 before the user has finished entering the complete query. The search engine 108 uses the transmitted portion of the partial query to predict the user's final complete query. These predictions are transmitted back to the user. If one of the predictions is the user's intended query, then the user can select the predicted query without having to complete entry of the query.

As further described herein, the searching system 100 and its functional components have been adapted so as to handle partial queries in multiple languages in a unified manner. The searching system 100 has been adapted so as to provide predicted queries based on the user's actual input at the client system 102, regardless of the language coding of the partial query transmitted by the search assistant 104 to the search engine 108. This is particularly useful, e.g., where a user has input a partial query using an incorrect input method editor setting at the client system 102.

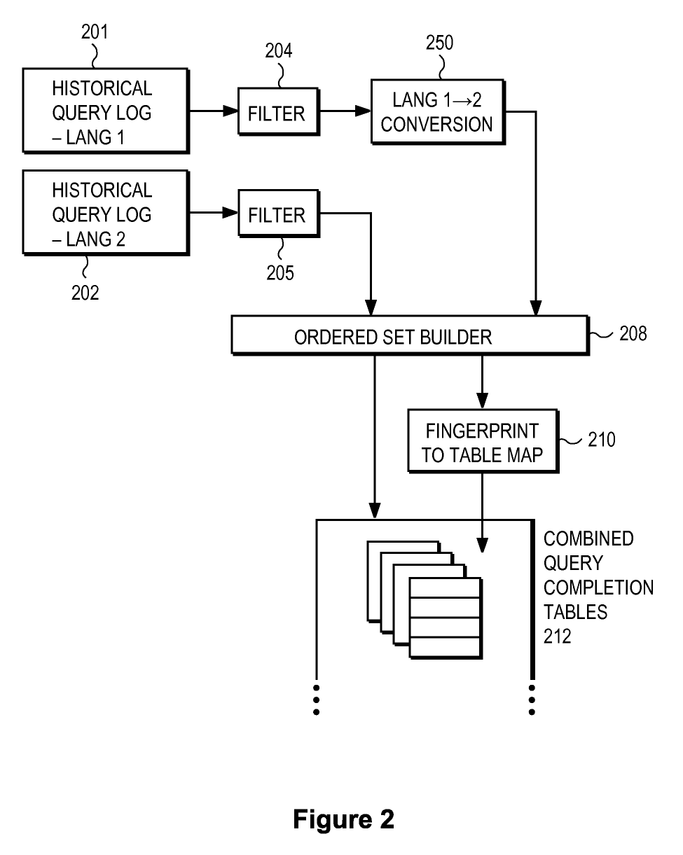

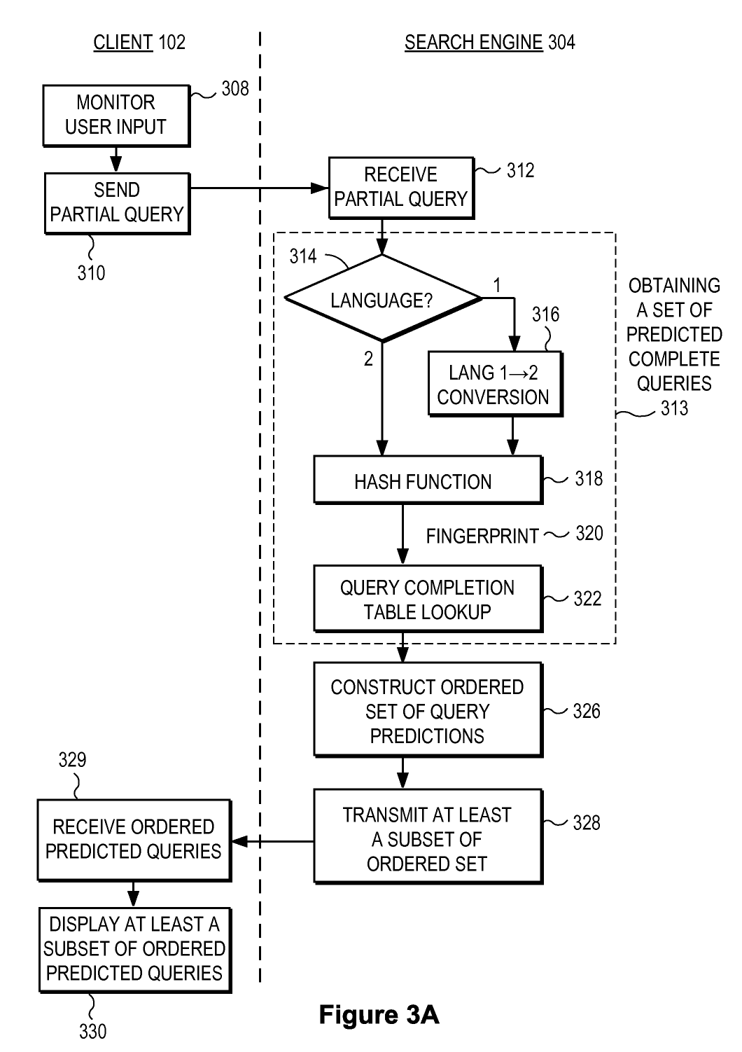

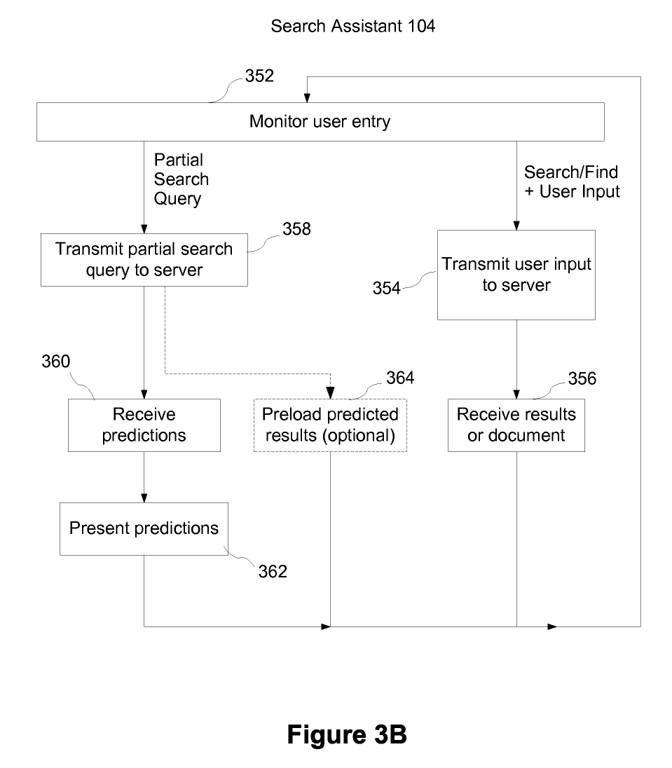

The search engine 108 includes a query server 110, which has a module 120 that receives and processes partial queries and forwards the partial queries to a prediction server 112. The prediction server 112 is responsible for generating a list of predicted complete queries corresponding to a received partial query. The prediction server 112 relies on data structures constructed by an ordered set builder 142 during a pre-processing phase. The ordered set builder 142 constructs the data structures using query logs in the different languages 124, 126. An embodiment of the pre-processing performed by the ordered set builder 142 is illustrated by FIG. 2. An embodiment of the processing performed by the prediction server 112 is illustrated by FIG. 3A. In some embodiments, the query server 110, in addition, receives complete search queries and forwards the complete search queries to a query processing module 114.

Referring to FIG. 2, two query logs are illustratively presented: a query log 201 in a first language and a query log 202 in a second language. The query logs 201, 202 contain logs of previously submitted queries in the respective languages received by the search engine from a community of users over a period of time. Optionally, the community of users who submitted the queries in query log 201 may be different from the community of users who submitted the queries in query log 202, in which case the aforementioned “community of users” includes two or more communities of users. Each query entry in the query logs 201, 202 can include meta-information, such as frequency information indicating how many times the query was submitted. Each of the query logs 201, 202 can be filtered by one or more language-specific filters 204, 205, for example to exclude queries that match one or more predefined sets of terms, such as words that may be considered to be objectionable, culturally sensitive, or the like. The queries in the query log 202 in the second language are utilized in their existing form. The queries in the query log 201 in the first language however are converted at 250 into a representation in the second language. The representation in the second language corresponds to the characters in the second language generated by a user attempting to input the query in the first language while using an input method set to the second language. For example, as further described below, queries in a language such as Korean can be represented by the keystrokes on an alphanumeric keyboard which correspond to inputting the Korean queries using an input method editor incorrectly set to English. However, in other embodiments the first language need not be Korean, and can instead be Japanese, Chinese, or any of a large number of other languages. Similarly, the second language need not be English, and can instead be French, German, Spanish, Russian or any of a large number of other languages. Filtered query log 202 and the output of the conversion of filtered query log 201 are combined and utilized together by an ordered set builder 208. The ordered set builder 208 creates one or more combined data structures, the combined data structure(s) capable of being used to process partial queries in both languages.

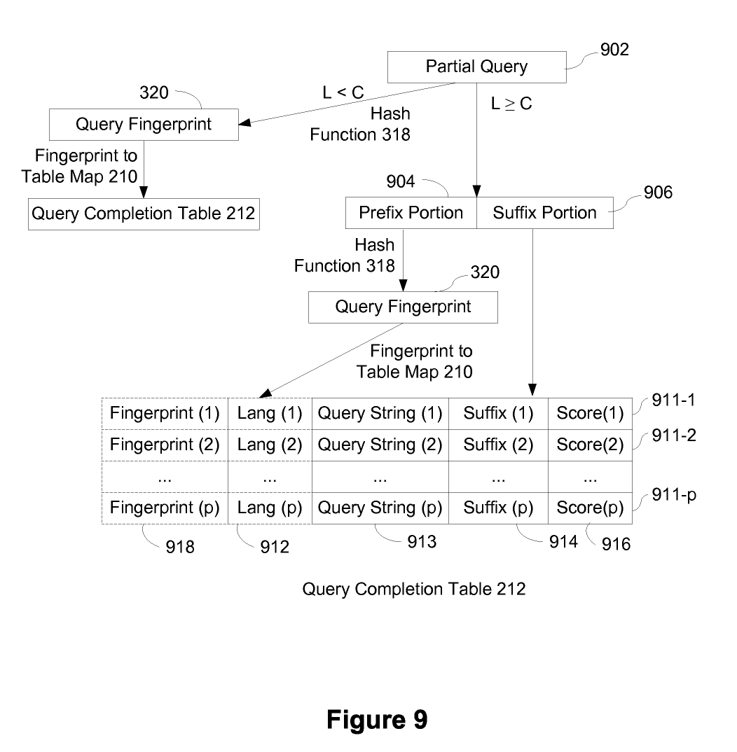

The ordered set builder 208 constructs one or more query completion tables 212. As further illustrated below, the one or more query completion tables 212 are used for generating predictions for both the first and the second languages. Each entry in the query completion tables 212 stores a query string and additional information. The additional information includes a ranking score, which may be based on the query's frequency in the query logs, date/time values of when the query was submitted by users in a community of users, and/or other factors. The additional information for the query optionally includes a value indicating the language of the complete search query. Each entry in a respective query completion table 212 represents a predicted complete query associated with a partial query. As described below with reference to FIG. 9, in some embodiments a received partial query is divided into two portions: a prefix portion and a suffix portion. Furthermore, in some embodiments a group of predicted complete queries associated with the same prefix are stored in a query completion table 212 sorted by frequency or score. Optionally, the query completion tables 212 are indexed by the query fingerprints of corresponding partial search queries, where the query fingerprint of each partial search query is generated by applying a hash function (or other fingerprint function) to either the partial search query or a prefix of the partial search query. Optionally, the query fingerprints are stored in a fingerprint to table map 210 for rapid lookup.

In some embodiments, the predicted complete queries in the first language (e.g., Korean, Japanese, Chinese, etc.) are stored in the one or more query completion tables 212 in the converted representation (e.g., a Romanized representation) using characters of the second language (e.g., English, Spanish, French, German, Russian, etc.). Thus, in these embodiments, the ordered set builder 208 stores the sets of complete second language (e.g., English) queries and complete first language (e.g., Korean) queries in their converted representation in one or more query completion data tables 212. Nevertheless, the predicted complete queries in the query completion table 212 are represented and displayed to a user in the language of the original query in the query log 201. However, in other embodiments, the predicted complete queries are stored in the one or more query completion tables 212 in their original languages, even though the queries in the first language are stored in query completion tables that are identified by applying a hash function (or other fingerprint function) to a converted representation of the corresponding partial search queries.

Referring to FIG. 3A, as a user enters a search query, the user's input is monitored by the client system 102 (308). Prior to the user (sometimes called the requester) signaling completion of the search query, at least a portion of the user's query is sent from the client system to the search engine 304 (310). The portion of the query may be a few characters, a search term, or more than one search term. Note that the partial query can be entered in either the first or the second language.

The search engine 304 receives the partial search query for processing (312) and proceeds to make predictions as to the user's contemplated complete query (313). First, the search engine 304 determines whether the partial query is encoded in the first or second language (314). If it is encoded in the first language, then the search engine 304 converts the partial query into the above-mentioned representation in the second language before proceeding (316). If it is encoded in the second language, then the search engine 304 can directly proceed to process the partial query. The search engine 304 then applies a hash function (or other fingerprint function) (318) to create a fingerprint 320. The search engine 304 performs a lookup operation (322) using the fingerprint 320 and the fingerprint-to-table map 210 to locate a query completion table 212 that corresponds to the partial query. The lookup operation includes searching the fingerprint-to-table map 210 for a fingerprint which matches the fingerprint 320 of the partial query. When a match is found, the corresponding entry of the fingerprint-to-table map 210 identifies a query completion table (or, alternately, a set of entries in a query completion table having entries for multiple partial queries). As described in more detail below, the query completion table 212 may include a plurality of entries that match or correspond to the partial query, and the fingerprint-to-table map 210 is used to locate the query completion table, or the first (or last) of those entries. The lookup operation (322) produces a set of predicted complete queries that correspond to the received partial search query.

Each entry in the query completion table includes a predicted complete query and other information such as the frequency or score for the predicted complete query. The search engine 304 uses the information to construct an ordered set of complete query predictions (326). In some embodiments, the set is ordered by frequency or score. The search engine 304 then returns at least a subset of predicted complete queries (328) to the client which receives the ordered predicted complete queries (329). The client proceeds to display at least a subset of the ordered predicted complete queries (330).

Note that the ordered set of complete query predictions can be in either language, since the partial query can potentially match to query entries in either language in the query completion tables 212. The search engine 304 can be configured to return mixed language predicted complete queries or can be configured to select whichever language is more likely to predict the partial query. Where the search engine 304 generates a predicted complete query in a language other than the language encoded in the partial query, the predicted complete query represents an automatic input method correction suggestion.

As noted above with reference to FIG. 2, queries from the historical query logs of a community of users may be filtered while building the query completion tables. However, additional filtering may be requested by or otherwise applied on behalf of various groups of users (e.g. users who have requested such filtering). Therefore, in some embodiments, either prior to ordering the predicted complete queries (326) or prior to conveying the predicted complete queries to the client (328), the set of predicted complete queries is filtered to remove queries, if any, matching one or more terms in one or more predefined sets of terms. For example, the one or more predefined sets of terms may include English terms and Korean terms that are considered to be objectionable, or culturally sensitive, or the like. The system performing the method may include, stored in memory, one or more tables (or other data structures) that identify the one or more predefined sets of terms. In some other embodiments, the set of predicted complete queries conveyed to the client (328) are filtered at the client to remove queries, if any, matching one or more terms in one or more predefined sets of terms. Optionally, a plurality of different filters may be used for a plurality of different groups of users. In some embodiments, run time filtering (performed in response to a partial search query) is used in place of filtering during the building of the query completion tables.

FIG. 3B illustrates an embodiment that may be implemented in the search assistant 104 of a client system 102. A search assistant 104 monitors the user's entry of a search query into a text entry box on a client system 102 (352). The user's entry may be one or more characters, or one or more words (e.g., the first word or two of a phrase, or a first word and the beginning letter, characters or symbols of a new word of a phrase of a compound term). The search assistant 104 may identify two different types of queries. First, the search assistant 104 receives or identifies a partial search query when an entry is identified prior to when the user indicates completion of the input string (as described below). Second, the search assistant 104 receives or identifies a user input when the user has selected a presented prediction, or indicated completion of the input string.

When a user input or selection is identified as a completed user input, the completed user input is transmitted to a server for processing (354). The server returns a set of search results, which is received by the search assistant 104 or by a client application, such as a browser application (356). In some embodiments, the browser application displays the search results at least as part of a web page. In some other embodiments, the search assistant 104 displays the search results. Alternately, the transmission of a completed user input (354) and the receipt (356) of search results may be performed by a mechanism other than a search assistant 104. For example, these operations may be performed by a browser application using standard request and response protocols.

A user input may be identified by the search assistant 104 (or by a browser or other application) as a completed user input, in a number of ways such as when the user enters a carriage return, or equivalent character, selects a “find” or “search” button in a graphical user interface (GUI) presented to the user during entry of the search query, or by selecting one of a set of predicted queries presented to the user during entry of the search query. One of ordinary skill in the art will recognize a number of ways to signal the final entry of the search query.

Prior to the user signaling a completed user input, a partial search query may be identified. For example, a partial search query is identified by detecting entry or deletion of characters in a text entry box. Once a partial search query is identified, the partial search query is transmitted to the server (358). In response to the partial search query, the server returns predictions, including predicted complete search queries. The search assistant 104 receives (360) and presents (e.g., displays, verbalizes, etc.) the predictions (362).

After the predicted complete queries are presented to the user (362), the user may select one of the predicted complete search queries if the user determines that one of the predictions matches the intended entry. In some instances, the predictions may provide the user with additional information which had not been considered. For example, a user may have one query in mind as part of a search strategy, but seeing the predicted complete queries causes the user to alter the input strategy. Once the set is presented (362), the user's input is again monitored (352). If the user selects one of the predictions, the user input is transmitted to the server (354) as a complete query (also herein called a completed user input). After the request is transmitted, the user's input activities are again monitored (352).

In some embodiments, the search assistant 104 may preload additional predicted results (each of which is a set of predicted complete queries) from the server (364). The preloaded predicted results may be used to improve the speed of response to user entries. For example, when the user enters <ban>, the search assistant 104 may preload the prediction results for <bana>, . . . , and <bank>, in addition to the prediction results for <ban>. If the user enters one more character, for example <k>, to make the (partial search query) entry <bank>, the prediction results for <bank> can be displayed without transmitting the partial search query to the server or receiving predictions.

In some embodiments, one or more sets of predicted results are cached locally at the client. When the search requester modifies the current query to reflect an earlier partial input (e.g., by backspacing to remove some characters), the set of predicted results associated with the earlier partial input is retrieved from the client cache and again presented again to the user instead of the partial input being sent to the server.

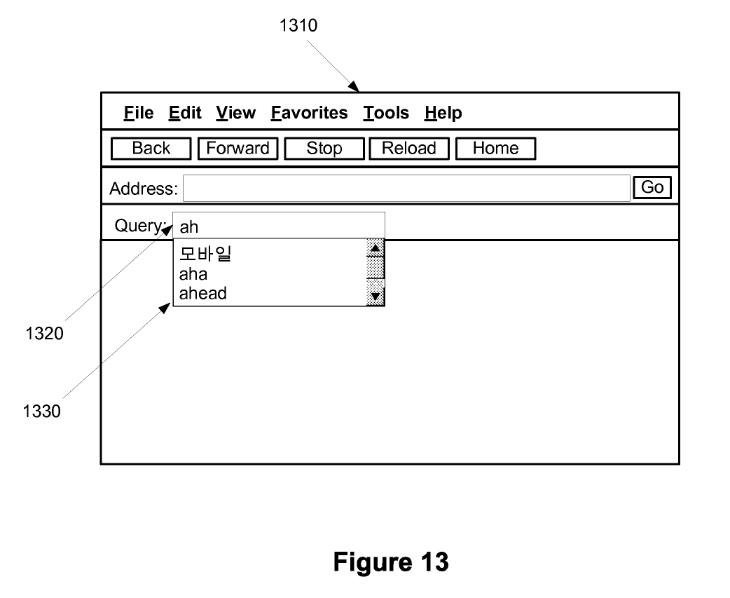

In some embodiments, after receiving the search results or document for a final input (356), or after displaying the predicted complete search queries (362), and optionally preloading predicted results (364), the search assistant 104 continues to monitor the user entry (352) until the user terminates the search assistant 104, for example by closing a web page that contains the search assistant 104. In some other embodiments, the search assistant 104 continues to monitor the user entry (352) only when a text entry box 1320 (discussed below with reference to FIG. 13) is activated and suspends the monitoring when the text entry box 1320 is deactivated. In some embodiments, a text entry box in a user interface is activated when it is displayed in a currently active window or toolbar of a browser application, and is deactivated when either the text entry box is not displayed or the text entry box is not in an active window or toolbar of the browser application.

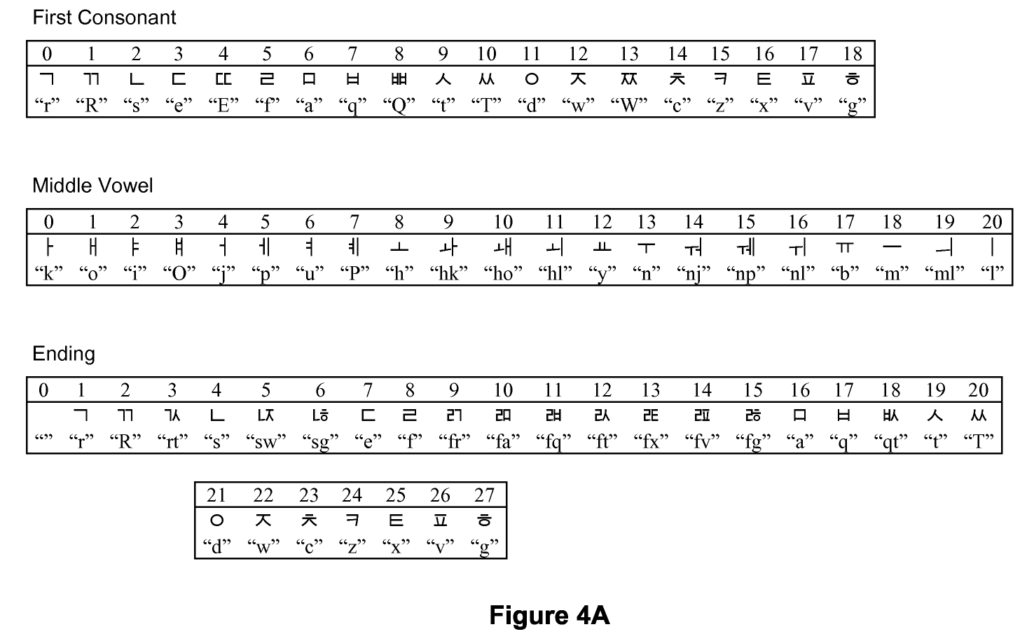

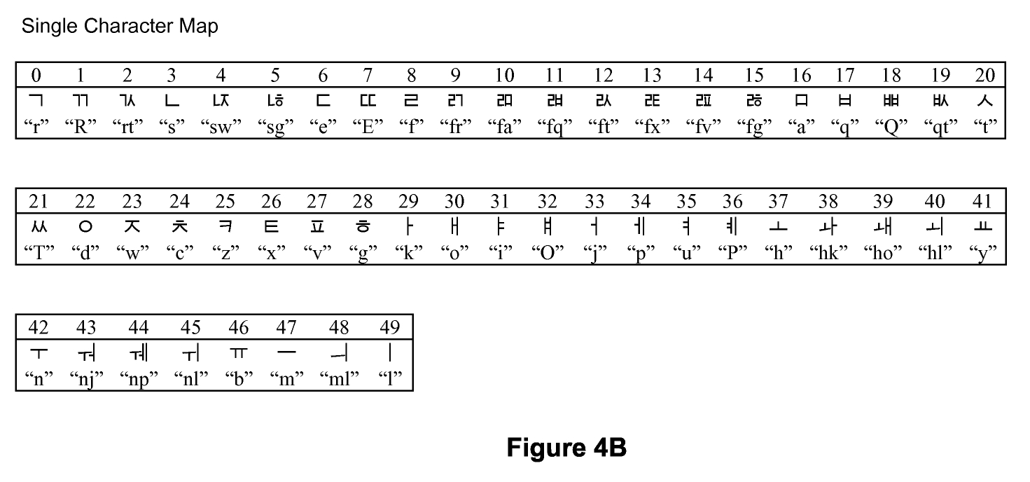

The described system and techniques have particular application to addressing partial queries in languages such as Korean, Japanese, Chinese, as well as many other languages. Written Korean, otherwise known as Hangul, utilizes a phonetic alphabet of characters organized into syllabic blocks. Each syllabic block is composed of one initial consonant, one middle vowel, and an optional ending consonant. There are 19 possible initial consonants, 21 possible vowels, and 27 possible ending consonants. A list of the possible initial, middle, and ending elements of a syllabic block is shown in FIGS. 4A and 4B. Korean text can be encoded in different ways, but it is conventionally represented in the Unicode Transmission Format using a different character code to represent each syllabic block combination: i.e., 11,172 predefined Korean characters from AC00 to D7AF. Korean text is conventionally entered using a western alphanumeric keyboard arrangement where the Korean consonants and vowels are mapped to letter keys on the keyboard. A single Korean syllabic block character requires between two to five keystrokes on the keyboard, because the initial consonant requires one keystroke, the middle vowel and the ending constant each require one or two keystrokes, and the ending consonant is optional.

Accordingly, a user entering a Korean query can be in the middle of entering an incomplete Korean character when the partial query is transmitted to the search engine 304. Moreover, the user may be trying to enter a Korean or English query using the incorrect input method setting.

The described system and techniques provides a unified solution to providing predicted complete queries in Korean and English by converting partial Korean queries into a Romanized representation. The Romanized representation of these Korean queries corresponds to the characters in a Romanized alphabet generated by a user attempting to input the Korean query using an English input method. For example, a Korean query log could include Korean words such as the following:
“ [symbol] ” (mobile)
“ [symbol] ” (google)

The Romanized representation of these Korean queries would be the following:
“ [symbol] ” (mobile)=>“ahqkdlf”
“ [symbol] ” (google)=>“rnrmf”

In other words, a user typing “ahqkdlf” on a keyboard set to a Korean input method would enter the word “mobile” in Korean.

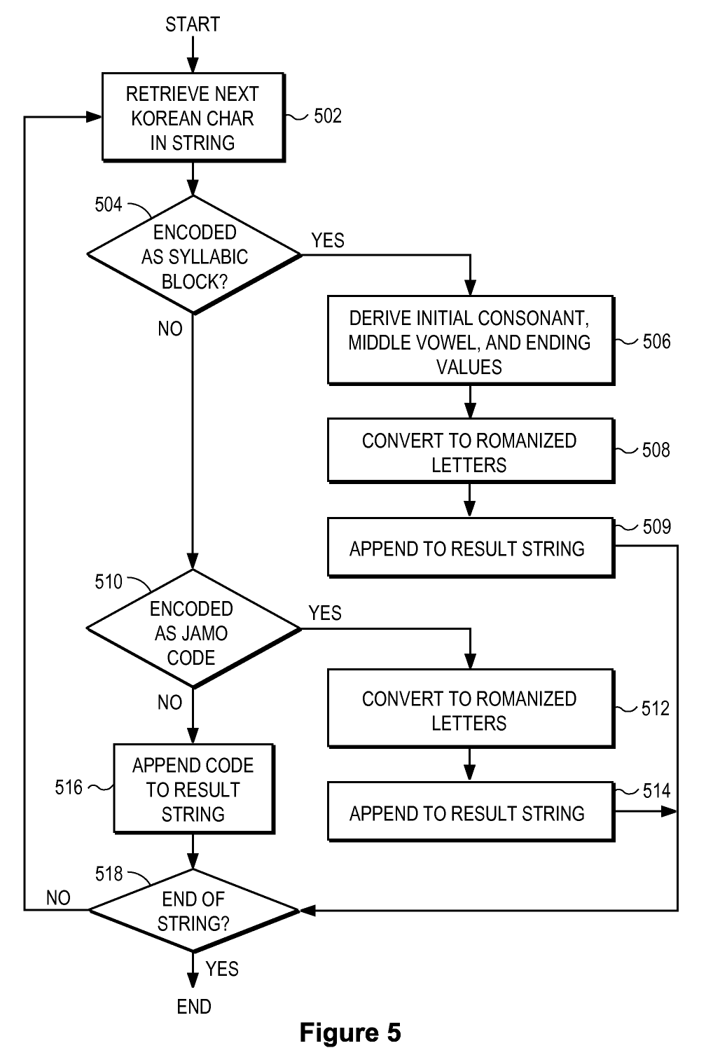

The conversion of a Korean character string in a query into a Romanized representation is illustrated by FIGS. 4A, 4B, and 5. In order to accomplish the conversion, an index is calculated for each consonant or vowel forming a constituent of each syllabic block character. For Korean characters represented in Unicode, the characters are arranged as:

Unicode=(initial consonant*21*28)+(middle vowel*28)+optional ending+0xAC00

This calculation can be accomplished by several modulations and divisions. Once an index has been determined for each Korean character, the English letters corresponding to the consonant and vowel indexes can be cascaded. FIGS. 4A and 4B show how the different Korean consonants and vowels can be mapped to corresponding Romanized characters given a Unicode encoding. FIG. 5 illustrates how the conversion can be processed. Referring to FIG. 5, a next character in a string (e.g., a complete or partial search query) is retrieved (502). Initially, the first character in the string represents the initial “next character.” A determination is made (504) as to whether the character is encoded in the range of syllabic block representations of Korean characters. If it is (504—Yes), the initial and middle and ending values are derived from the character (506), as described above. The values are then mapped to Romanized characters (508), in accordance with FIGS. 4A and 4B. The Romanized characters are then appended to a result string (509). If the character, on the other hand, is encoded not as a syllabic block character (504-No) but as a single consonant or vowel (510-Yes), then the consonant or vowel (encoded as a jamo code) is directly converted into the Romanized representation (512), again in accordance with the mapping set forth in FIGS. 4A and 4B, and then appended to the end of the result string (514). If the character is not encoded in Korean (510-No), then the character can be directly appended to result string (516), since it is assumed to already be in a Romanized representation. The process iterates (518) until the end of the string is reached.

As described above, the Korean queries are converted into a Romanized representation during the pre-processing phase and are organized in the data structures in accordance with their Romanized representation. By converting Korean queries into a Romanized representation, both Korean and English predicted complete queries can be stored together in a unified data structures for the prediction server. Since both English queries and Korean queries are represented using a Romanized alphabet, the same prediction logic can be utilized to generate English predictions and Korean predictions.

When a user enters a partial query in Korean into the system, the Korean partial query is converted into its Romanized representation. The Romanized representation is then checked, like any English partial query, against the data structure for the partial queries. Incomplete Korean queries are correctly handled, since the Korean characters are represented by Romanized letters which have the same sequence as the original key strokes on the keyboard. A list of predictions (i.e., complete queries) is generated based on the partial query. The predicted complete queries notably may be in either Korean or English. Thus, in some cases the predicted complete queries corresponding to a partial query include both Korean and English language complete queries. Where the user incorrectly enters an English partial query using a Korean input method, the Romanized representation will be recognized by the system as potentially being an English query. For example, a user can enter the following query or a partial query of the following:
“ [symbol] ”

The query will not generate any Korean predictions, since it does not form any correct syllabic blocks. The Romanized representation, however, for the query is “mobile” which will match predicted complete queries that include the English word “mobile”, even though the language encoding for the partial query is incorrect.

When a user enters a partial query in English into the system, the system will handle the partial query as normally. The English query will be checked against the data structure and a list of predictions generated. Moreover, since the data structure includes Korean queries in a Romanized representation, the system will automatically identify Korean predictions resulting from an input method error.

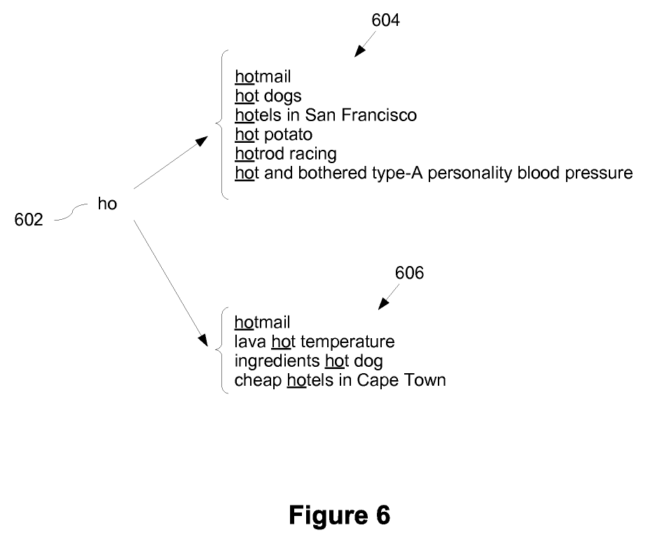

FIG. 6 shows an example of a set of predicted complete queries 604 corresponding to a partial query, “ho” 602. In this example, the first position in the set of completed queries 604 includes the query (e.g., “hotmail”) having the highest frequency value, the second position in the set is occupied by the query (e.g., “hot dogs”) having the next highest frequency value, and so on. In this example, correspondence between a given partial query and a complete query is determined by the presence of the partial query at the beginning of the complete query (e.g., the characters of “ho” are found at the beginning of the complete queries “hotmail” and “hotels in San Francisco”). In other embodiments, correspondence between a given partial query and complete queries is determined by the presence of the partial query at the beginning of a search term located anywhere in the complete query, as illustrated by the set of complete queries 606 (e.g., the characters “ho” are found at the beginning of “hotmail” and at the beginning of the second search term in “cheap hotels in Cape Town”).

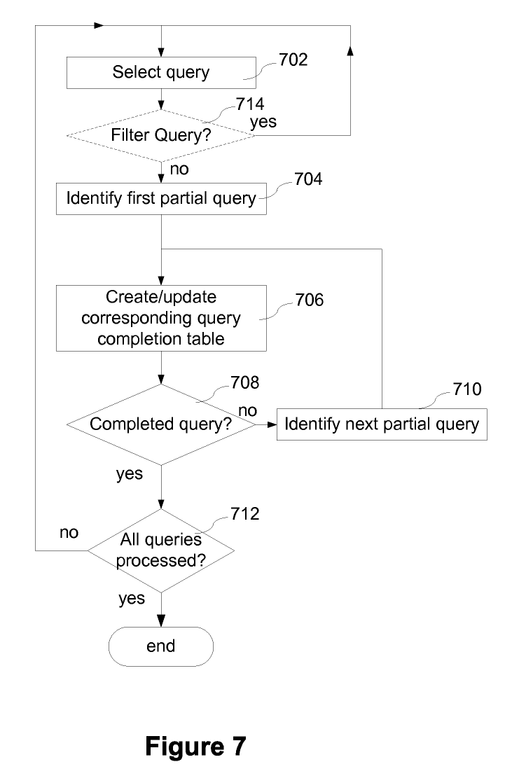

To create the set of query completion tables 212, a query from the historical query logs 201, 202 is selected (FIG. 7, 702). In some embodiments, only queries having the desired meta-information are processed (e.g., queries in the English language). A first partial query is identified from the selected query (704). In one embodiment, the first partial query is the first character of the selected query (i.e., “h” for a query string of “hot dog ingredients”). In some embodiments, preprocessing is applied before partial queries are identified (e.g., converting uppercase letters to lowercase letters). An entry is made in a table which indicates the partial query, the complete query corresponding to the partial query and its frequency. In other embodiments, other information which is used for ranking is stored (e.g., a ranking score computed based on date/time values of when the complete query was submitted by a community of users, and/or other factors). If the identified partial query does not represent the entire query, then the query processing is not complete (708-no). Accordingly, the next partial query is identified (710). In some embodiments, the next partial query is identified by adding the next additional character to the partial query previously identified (i.e., “ho” for a query string of “hot dog ingredients”). The process of identifying (710) and of updating of a query completion table (706) continues until the entire query is processed (708-yes). If all of the queries have not yet been processed (712-no), then the next query from the historical query log(s) is selected (702) and processed until all queries are processed (712-yes). In some embodiments, as items are added to a query completion table, the items are inserted so that the items in the table are ordered in accordance with the rank or score. In another embodiment, all the query completion tables are sorted at the end of the table building process so that the items in each query completion table are ordered in accordance with the rank or score of the items in the query completion table. In addition, one or more query completion tables may be truncated so that the table contains no more than a predefined number of entries.

As noted above, in some embodiments, complete queries from the historical query logs 201, 202 are filtered (714) prior to inserting them in the query completion tables to exclude queries that match one or more predefined sets of terms, such as words that may be considered to be objectionable, culturally sensitive, or the like. Optionally, the community of users who submitted the queries in query log 201 may be different from the community of users who submitted the queries in query log 202, in which case the aforementioned “community of users” includes two or more communities of users. If a query is filtered and thereby removed from the set of queries that are candidates for insertion into the query completion tables, a next query (if any) from the historical query logs 201, 202 is selected (702).

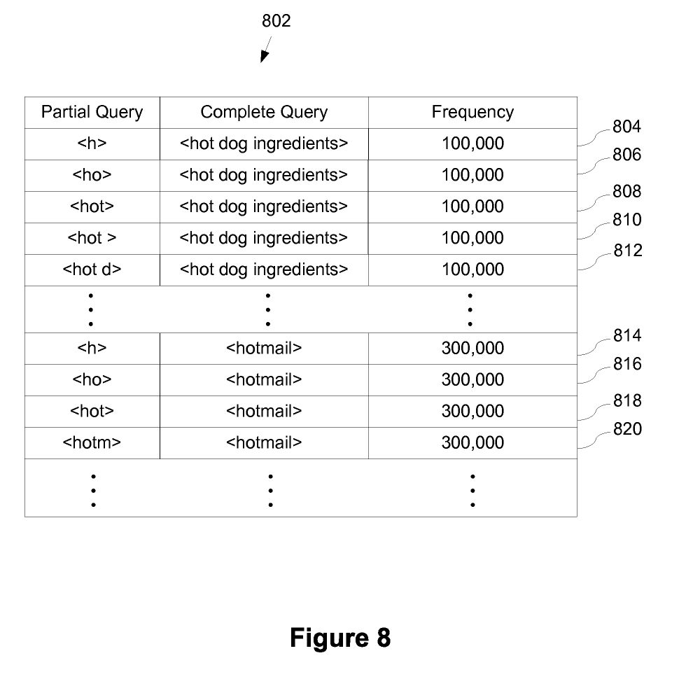

Referring to FIG. 8, an exemplary processing of the first five characters of the query string of “hot dog ingredients” is illustrated in table 802 at 804 through 812. An exemplary processing of the first four characters of the query string of “hotmail” is illustrated at 814 through 820.

In some embodiments, a query completion table for a given partial query is created by identifying the n most frequently submitted queries corresponding to the given partial query from the table and placing them in ranked order such that the query having the highest rank (e.g., the highest ranking score or frequency) is at the top of the list. For example, a query completion table for the partial query “hot” would include both complete query strings of 808 and 818. When the ranking is based on frequency, the query string for “hotmail” would appear above the query string for “hot dog ingredients” because the frequency of the query string in 818 (i.e., 300,000) is larger than that of the query string in 808 (i.e., 100,000). Accordingly, when the ordered set of predictions is returned to the user, the queries having a higher likelihood of being selected are presented first. As mentioned above, other values could be used for ranking the predicted complete queries. In some embodiments, personalization information from a user's profile could be used for ranking the predicted complete queries.

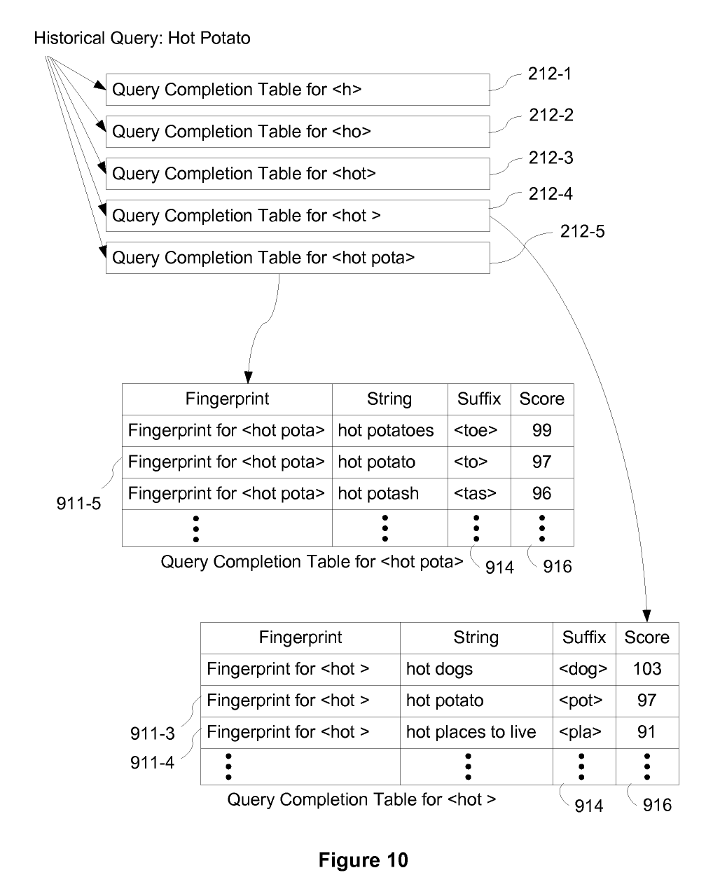

Referring to FIGS. 9 and 10, in some embodiments the number of query completion tables 212 is reduced by dividing the historical query strings into “chunks” of a predefined size C, such as four (4) characters. The query completion tables 212 for partial queries of length less than C remain unchanged. For partial queries whose length is at least C, the partial query is divided into two portions: a prefix portion and a suffix portion. The length of the suffix portion, S, is equal to the length of the partial query (L) modulo C:

S=L modulo C.

where L is the length of the partial query. The length of the prefix portion, P, is the length of the partial query minus the length of the suffix: P=L−S. Thus, for example, a partial query having a length of ten (10) characters (e.g., “hot potato”), would have a suffix length S=2 and a prefix length P=8 when the chunk size C is four (4).

When performing the process shown in FIG. 7, step 706, identifying or creating a query completion table corresponding to a partial query is conceptually illustrated in FIG. 9. FIG. 9 schematically illustrates the process used both for generating query completion tables as well as for lookup when processing a user entered partial query. When the length of the partial query is less than the size of one “chunk”, C, the partial query is mapped to a query fingerprint 320, for example by using a hash function (or other fingerprint function) 318 (FIG. 3A). The fingerprint 320 is mapped to a query completion table 212 by a fingerprint to table map 210.

When the length of the partial query is at least the size of one chunk, C, the partial query 902 is decomposed into a prefix 904 and suffix 906, whose lengths are governed by the chunk size, as explained above. A fingerprint 908 is generated for the prefix 904, for example by applying a hash function 318 to the prefix 904, and that fingerprint 908 is then mapped to a “chunked” query completion table 212 by a fingerprint to table map 210. In some embodiments, each chunked query completion table 212 is a set of entries in a bigger query completion table, while in other embodiments each chunked query completion table is a separate data structure. Each entry 911 of a respective query completion table includes a query string, which is the text of a complete query, and may optionally include a score 916 as well, used for ordering the entries in the query completion table 212. Each entry of a chunked query completion table includes the suffix 914 of a corresponding partial query. The suffix 914 in a respective entry 911 has a length, S, which can be anywhere from zero to C-1, and comprises the zero or more characters of the partial query that are not included in the prefix 904. In some embodiments, when generating the query completion table entries 911 for a historical query, only one entry is made in each chunked query completion table 212 that corresponds to the historical query. In particular, that one entry 911 contains the longest possible suffix for the historical query, up to C-1 characters long. In other embodiments, up to C entries are made in each chunked query completion table 212 for a particular historical query, one for each distinct suffix.

Optionally, each entry in a respective query completion table 212 includes a language value or indicator 912, indicating the language associated with the complete query 913. However, a language value 912 may be omitted in embodiments in which all the query strings 913 are stored in the query completion tables 212 in their original language.

Optionally, each entry in a respective query completion table 212 includes a query fingerprint 918, for matching table entries to the fingerprint of a partial query prefix. However, in some embodiments (e.g., embodiments that have a separate query completion tables 212 for each distinct partial query prefix), the fingerprint 918 may be omitted from the entries of the query completion tables 212.

FIG. 10 shows a set of query completion tables which contain entries 911 corresponding to the historical query “hot potato”. This example assumes a chunk size, C, equal to four. In other embodiments the chunk size may be 2, 3, 5, 6, 7, 8, or any other suitable value. The chunk size, C, may be selected based on empirical information. The first three of the query completion tables shown in FIG. 10, 212-1 through 212-3, are for the partial queries “h”, “ho” and “hot”, respectively. The next two query completion tables, 212-4 and 212-5 correspond to the partial queries “hot pot” (having “hot” as its prefix portion, and “pot” as its suffix portion) and “hot potato” (having “hot pota” as its prefix portion, and “to” as its suffix portion), respectively, having partial query lengths of 7 and 10. Stated in another way, query completion table 212-4 corresponds to all partial queries that begin with “hot” and have a length between 4 and 7; while query completion table 212-5 corresponds to all partial queries that begin with “hot pota” and have a length between 8 and 11.

Referring back to FIG. 7, with each iteration of the loop formed in part by operation 710, the length of the partial queries initially increases by steps of one character, until a length of C-1 is reached, and then the length of the partial queries increases by steps of C characters, until the full length of the historical query is reached. As a result, when C=4, the historical query “hot potato” produces query completion table entries in five such tables (212-1 to 212-5) corresponding to partial search queries (shown in FIG. 10) having lengths of 1, 2, 3, 4-7 and 8-10 characters, respectively.

The entries 911 of each chunked query completion table are ordered according to the ranking values (represented by scores 916) of the query strings 913 in the entries 911. For partial queries having less than C characters, the number of queries in the query completion table 212 is a first value (e.g., 10, 20, or any suitable value between 4 and 20), which may represent the number of queries to return as predictions. In some embodiments, the maximum number (e.g., a number between 1000 and 10,000) of entries 911 in each chunked query completion table 910 is significantly greater than the first value. Each chunked query completion table 212 may take the place of dozens or hundreds of ordinary query completion tables. Therefore, each chunked query completion table 212 is sized so as to contain a number (p) of entries corresponding to all or almost all of the authorized historical queries having a prefix portion that corresponds to the chunked query completion table, while not being so long as to cause an undue latency in generating a list of predicted complete queries for a user specified partial query.

After the query completion tables 212 and fingerprint-to-table maps 210 have been generated from a set of historical queries, these same data structures (or copies thereof) are used for identify a predicted set of queries corresponding to a user entered partial query. As shown in FIG. 9, the user entered partial query is first mapped to a query fingerprint 320, by applying a hash function (or other fingerprint function) 318 either to the entire partial query 902 or to a prefix portion 904 of the partial query, as determined by the length of the partial query. The query fingerprint 320 is then mapped to a query completion table 212 by performing a lookup of the query fingerprint in a fingerprint-to-table map 210. Finally, an ordered set of up to N predicted queries is extracted from the identified query completion table. When the length of the partial query is less than the chunk size, the ordered set of predicted queries are the top N queries in the identified query completion table. When the length of the partial query is equal to or longer than the chunk size, the identified query completion table is searched for the top N items that match the suffix of the partial query. Since the entries in the query completion table 212 are ordered in decreasing rank, the process of searching for matching entries begins at the top and continues until the desired number (N) of predictions to return is obtained (e.g., 10) or until the end of the query completion table 212 is reached. A “match” exists when the suffix 906 of the partial query is the same as the corresponding portion of the suffix 914 in an entry 911. For instance, referring to FIG. 10, a one letter suffix of <p> matches entries 911-3 and 911-4 having suffixes of <pot> and <pla>, respectively. An empty suffix (also called a null string) having length zero matches all entries in a query completion table, and therefore when the suffix portion of a partial query is a null string, the top N items in the table are returned as the predicted queries.

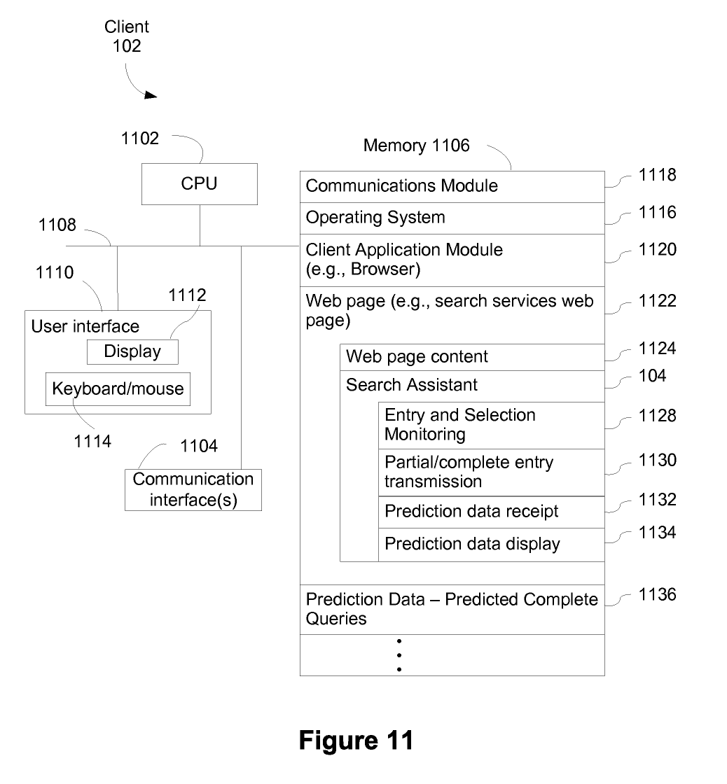

Referring to FIG. 11, an embodiment of a client system 102 that implements the methods described above includes one or more processing units (CPU's) 1102, one or more network or other communications interfaces 1104, memory 1106, and one or more communication buses 1108 for interconnecting these components. In some embodiments, fewer and/or additional components, modules or functions are included in the client system 102. The communication buses 1108 may include circuitry (sometimes called a chipset) that interconnects and controls communications between system components. The client 102 may optionally include a user interface 1110. In some embodiments, the user interface 1110 includes a display device 1112 and/or a keyboard 1114, but other configurations of user interface devices may be used as well. Memory 1106 may include high speed random access memory and may also include non-volatile memory, such as one or more magnetic or optical storage disks, flash memory devices, or other non-volatile solid state storage devices. The high speed random access memory may include memory devices such as DRAM, SRAM, DDR RAM or other random access solid state memory devices. Memory 1106 may optionally include mass storage that is remotely located from CPU's 1102. Memory 1106, or alternately the non-volatile memory device(s) within memory 1106, comprises a computer readable storage medium. Memory 1106 stores the following elements, or a subset of these elements, and may also include additional elements:
an operating system 1116 that includes procedures for handling various basic system services and for performing hardware dependent tasks;
a network communication module (or instructions) 1118 that is used for connecting the client system 102 to other computers via the one or more communications network interfaces 1104 and one or more communications networks, such as the Internet, other wide area networks, local area networks, metropolitan area networks, and so on;
a client application 1120 (e.g., an Internet browser application); the client application may include instructions for interfacing with a user to receive search queries, submitting the search queries to a server or online service, and for displaying or otherwise presenting search results;
a web page 1122, which includes web page content 1124 to be displayed or otherwise presented on the client 102; the web page in conjunction with the client application 1120 implements a graphical user interface for presenting web page content 1124 and for interacting with a user of the client 102;
data 1136 including predicted complete search queries; and
a search assistant 104.

At a minimum, the search assistant 104 transmits partial search query information to a server. The search assistant may also enable the display of prediction data including the predicted complete queries, and user selection of a displayed predicted complete search query. In some embodiments, the search assistant 104 includes the following elements, or a subset of such elements: an entry and selection monitoring module (or instructions) 1128 for monitoring the entry of search queries and selecting partial search queries for transmission to the server; a partial/complete entry transmission module (or instructions) 1130 for transmitting partial search queries and (optionally) completed search queries to the server; a prediction data receipt module (or instructions) 1132 for receiving predicted complete queries; and prediction data display module (or instructions) 1134 for displaying at least a subset of predicted complete queries and any additional information. The transmission of final (i.e., completed) queries, receiving search results for completed queries, and displaying such results may be handled by the client application/browser 1120, the search assistant 104, or a combination thereof. The search assistant 104 can be implemented in many ways.

In some embodiments, a web page (or web pages) 1122 used for entry of a query and for presenting responses to the query also includes JavaScript or other embedded code, for example a Macromedia Flash object or a Microsoft Silverlight object (both of which work with respective browser plug-ins), or instructions to facilitate transmission of partial search queries to a server, for receiving and displaying predicted search queries, and for responding to user selection of any of the predicted search queries. In particular, in some embodiments the search assistant 104 is embedded in the web page 1122, for example as an executable function, implemented using JavaScript (trademark of Sun Microsystems) or other instructions executable by the client 102. Alternately, the search assistant 104 is implemented as part of the client application 1120, or as an extension, plug-in or toolbar of the client application 1120 that is executed by the client 102 in conjunction with the client application 1120. In yet other embodiments, the search assistant 104 is implemented as a program that is separate from the client application 1120.

In some embodiments, a system for processing query information includes one or more central processing units for executing programs and memory to store data and to store programs to be executed by the one or more central processing units. The memory stores a set of complete queries previously submitted by a community of users, ordered in accordance with a ranking function, the set corresponding to a partial search query and including both English language and Korean language complete search queries. The memory further stores a receiving module for receiving the partial search query from a search requester, a prediction module for associating the set of predicted complete queries to the partial search query, and a transmission module for transmitting at least a portion of the set to the search requester.

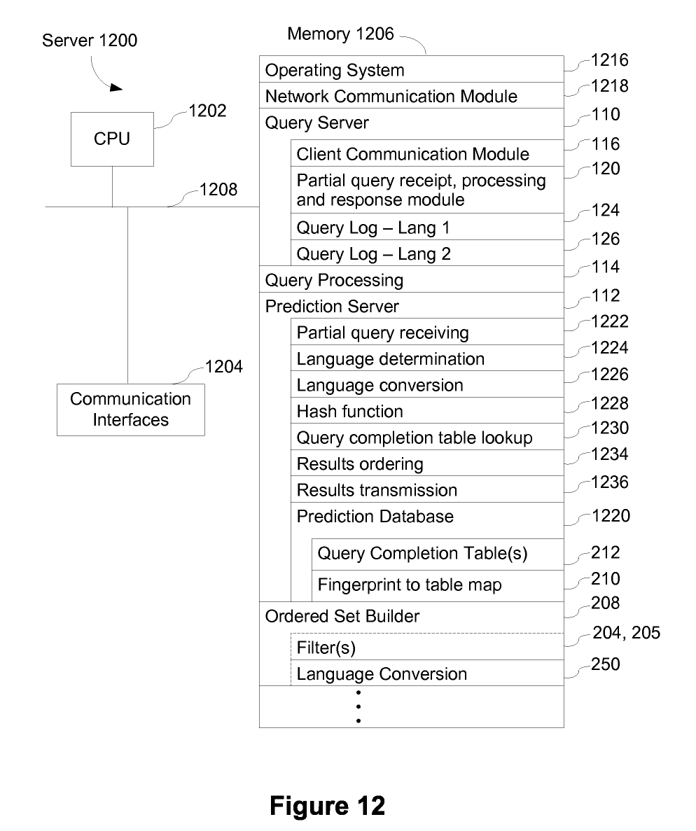

FIG. 12 depicts an embodiment of a server system 1200 that implements the methods described above. The server system 1200 corresponds to the search engine 108 in FIG. 1 and the search engine 304 in FIG. 3A. The server system 1200 includes one or more processing units (CPU's) 1202, one or more network or other communications interfaces 1204, memory 1206, and one or more communication buses 1208 for interconnecting these components. The communication buses 1208 may include circuitry (sometimes called a chipset) that interconnects and controls communications between system components. It should be understood that in some other embodiments the server system 1200 may be implemented using multiple servers so as to improve its throughput and reliability. For instance the query logs 124 and 126 could be implemented on a distinct server that communicates with and works in conjunction with other ones of the servers in the server system 1200. As another example, the ordered set builder 208 could be implemented in separate servers or computing devices. Thus, FIG. 12 is intended more as functional description of the various features which may be present in a set of servers than as a structural schematic of the embodiments described herein. The actual number of servers used to implement a server system 1200 and how features are allocated among them will vary from one implementation to another, and may depend in part on the amount of data traffic that the system must handle during peak usage periods as well as during average usage periods.

Memory 1206 may include high speed random access memory and may also include non-volatile memory, such as one or more magnetic or optical storage disks, flash memory devices, or other non-volatile solid state storage devices. The high speed random access memory may include memory devices such as DRAM, SRAM, DDR RAM or other random access solid state memory devices. Memory 1206 may optionally include mass storage that is remotely located from CPU's 1202. Memory 1206, or alternately the non-volatile memory device(s) within memory 1206, comprises a computer readable storage medium. Memory 1206 stores the following elements, or a subset of these elements, and may also include additional elements:
an operating system 1216 that includes procedures for handling various basic system services and for performing hardware dependent tasks;
a network communication module (or instructions) 1218 that is used for connecting the server system 1200 to other computers via the one or more communications network interfaces 1204 and one or more communications networks, such as the Internet, other wide area networks, local area networks, metropolitan area networks, and so on;
a query server 110 for receiving, from a client, partial search queries and complete search queries and conveying responses; and
a prediction server 112 for receiving, from the query server 110, partial search queries and for producing and conveying responses.

The query server 110 may include the following elements, or a subset of these elements, and may also include additional elements:
a client communication module (or instructions) 116 that is used for communicating queries and responses with a client;
a partial query receipt, processing and response module (or instructions) 120; and
one or more query log 124 and 126 that contains information about queries submitted by a community of users.

The query processing module (or instructions) 114 receives, from the query server 110, complete search queries, and produces and conveys responses. In some embodiments, the query processing module (or instructions) includes a database that contains information including query results and optionally additional information, for example advertisements associated with the query results.

The prediction server 112 may include the following elements, a subset of these elements, and may also include additional elements:
a partial query receiving module (or instructions) 1222;
a language determination module (or instructions) 1224;
a language conversion module (or instructions) 1226;
a hash function (or other fingerprint function) 1228;
a module (or instructions) for query completion table lookup 1230;
a results ordering module (or instructions) 1232;
a results transmission module (or instructions) 1234; and
a prediction database 1220 that may include one or more query completion tables 212 and one or more fingerprint to table maps 210 (described above with reference to FIG. 2).

The ordered set builder 208 may optionally include one or more filters 204, 205 and/or language conversion module (or instructions) 250.

Although the discussion herein has been made with reference to a server designed for use with a prediction database remotely located from the search requester, it should be understood that the concepts disclosed herein are equally applicable to other search environments. For example, the same techniques described herein could apply to queries against any type of information repository against which queries, or searches, are run. Accordingly, the term “server” should be broadly construed to encompass all such uses.

Although illustrated in FIGS. 11 and 12 as distinct modules or components, the various modules or components may be located or co-located within either the server or the client. For example, in some embodiments, portions of prediction server 112, and/or the prediction database 1220 are resident on the client system 102 or form part of the search assistant 104. For example, in some embodiments hash function 1228 and one or more query completion tables 212 and one or more fingerprint to table maps 210 for the most popular searches may be periodically downloaded to a client system 102, thereby providing fully client-based processing for at least some partially search queries.

In another embodiment, the search assistant 104 may include a local version of the prediction server 112, for making complete search query predictions based at least in part on prior queries by the user. Alternately, or in addition, the local prediction server may generate predictions based on data downloaded from a server or remote prediction server. Further, the search assistant 104 may merge locally generated and remotely generated prediction sets for presentation to the user. The results could be merged in any of a number of ways, for example, by interleaving the two sets or by merging the sets while biasing queries previously submitted by the user such that those queries would tend to be placed or inserted toward the top of the combined list of predicted queries. In some embodiments, the search assistant 104 inserts queries deemed important to the user into the set of predictions. For example, a query frequently submitted by the user, but not included in the set obtained from the server could be inserted into the predictions.

Operations shown in flow charts, such as in FIG. 3A, 3B, 5, 7 and 9, and other operations described in this document as being performed by a client system, a server, a search engine or the like correspond to instructions stored in a computer readable storage medium of a respective client system, server or other computer system. Examples of such computer readable storage media are shown in FIG. 11 (memory 1106) and FIG. 12 (memory 1206). Each of the software modules, programs and/or executable functions described in this document correspond to instructions stored in respective computer readable storage media, and corresponds to a set of instructions for performing a function described above. The identified modules, programs and/or functions (i.e., sets of instructions) need not be implemented as separate software programs, procedures or modules, and thus various subsets of these modules may be combined or otherwise re-arranged in various embodiments.

FIG. 13 illustrates a user interface of an illustrative client system. In this example, a window 1310 of a browser application includes a text entry box 1320 depicting the entry of a partial query <ah>. In response to detecting the partial query and receiving predicted complete queries from a prediction server or search engine, at least a subset of the predicted complete queries are displayed in a display area 1330 for possible selection by the user of the client system. As depicted, the predicted complete queries are presented in a drop-down box (corresponding to display area 1330) that extends from the text entry box 1320. Note that entry of the partial query <ah> generates English language results (predicted complete queries), namely <aha> and <ahead>, as well as a Korean language result. This is because the Korean language result corresponds to a Romanized representation of <ahqkdlf>, as mentioned above. Accordingly, if partial query was entered mistakenly due to an input method error (e.g., using English character entry instead of Korean or Hangul text entry) on the part of the user, and the prediction results include a Korean language query of interest to the user, the user may avoid re-entry of the partial query by selecting the desired Korean language query.

Although some of the various drawings illustrate a number of logical stages in a particular order, stages which are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for processing query information, comprising:
at a server,
receiving from a search requester a partial search query, the search requester located remotely from the server;
obtaining a set of predicted complete queries corresponding to the partial search query from a plurality of previously submitted complete queries, the previously submitted complete queries submitted by a community of users; the set of predicted complete queries including both first language and second language complete search queries;
ordering the set of predicted complete queries in accordance with ranking criteria; and
conveying at least a subset of the ordered set to the search requestor.

2. The method of claim 1, wherein the first language is Korean and the second language is English.

3. The method of claim 1, wherein, when the partial search query comprises a partially entered first language search query, the method includes generating a Romanized representation of the partial search query.

4. The method of claim 1, wherein, when the received partial search query includes one or more first language characters, obtaining a set of predicted complete queries includes:
converting the partial search query into a representation of the partial search query in characters of the second language;
applying a hash function to the representation of the partial search query to produce a hash value; and
performing a lookup operation using the hash value to obtain the predicted complete queries.

5. The method of claim 1, wherein, when the received partial search query includes one or more complete first language characters and an incomplete first language character, obtaining a set of predicted complete queries includes:
converting the partial search query into a Romanized representation of the partial search query;
applying a hash function to the Romanized representation of the partial search query to produce a hash value; and
performing a lookup operation using the hash value to obtain the predicted complete queries.

6. The method of claim 1, wherein the received partial search query includes one or more complete first language characters and an incomplete first language character.

7. The method of claim 1, including, prior to the conveying, filtering the set of predicted complete queries to remove queries, if any, matching one or more terms in one or more predefined sets of terms.

8. A method for processing query information, comprising:
at a client,
receiving from a search requestor a partial search query;
obtaining a set of predicted complete queries corresponding to the partial search query from a plurality of previously submitted complete queries, the previously submitted complete queries submitted by a community of users, wherein the set of predicted complete queries includes both first language and second language complete search queries and is ordered in accordance with ranking criteria; and
displaying at least a subset of the ordered set to the search requester.

9. The method of claim 8, wherein the first language is Korean and the second language is English.

10. The method of claim 8, wherein, when the partial search query comprises a partially entered first language search query, the method includes generating a Romanized representation of the partial first language search query.

11. The method of claim 8, wherein the obtaining includes when the received partial search query includes one or more first language characters:
converting the partial search query into a representation of the partial search query in characters of the second language;
applying a hash function to the representation of the partial search query to produce a hash value; and
performing a lookup operation using the hash value to obtain the predicted complete queries.

12. The method of claim 8, wherein the obtaining includes
when the received partial search query includes one or more complete first language characters and an incomplete first language character, converting the partial search query into a Romanized representation of the partial search query, applying a hash function to the Romanized representation of the partial search query to produce a hash value, and performing a lookup operation using the hash value to obtain the predicted complete queries.

13. The method of claim 8, wherein the received partial search query includes one or more complete first language characters and an incomplete first language character.

14. A system for processing query information, comprising:
one or more central processing units for executing programs; and
memory to store data and to store one or more programs to be executed by the one or more central processing units, the one or more programs including instructions for:
receiving from a search requestor a partial search query, the search requestor located remotely from the server;
obtaining a set of predicted complete queries corresponding to the partial search query from a plurality of previously submitted complete queries, the previously submitted complete queries submitted by a community of users; the set of predicted complete queries including complete search queries in both a first language and a second language distinct from the first language;
ordering the set of predicted complete queries in accordance with ranking criteria; and
conveying at least a subset of the ordered set to the search requester.

15. The system of claim 14, wherein the one or more programs include instructions for generating a Romanized representation of a respective partial search query that comprises a partially entered first language search query.

16. The system of claim 14, wherein the instructions for obtaining a set of predicted complete queries include instructions for:
converting a respective partial search query that includes one or more first language characters into a representation of the respective partial search query in characters of the second language;
applying a hash function to the representation of the partial search query to produce a hash value; and
performing a lookup operation using the hash value to obtain the predicted complete queries.

17. The system of claim 14, wherein the instructions for obtaining a set of predicted complete queries include instructions for:
converting a respective partial search query that includes one or more complete first language characters and an incomplete first language character into a Romanized representation of the respective partial search query;
applying a hash function to the Romanized representation of the respective partial search query to produce a hash value; and
performing a lookup operation using the hash value to obtain the predicted complete queries.

18. The system of claim 14, wherein the received partial search query includes one or more complete first language characters and an incomplete first language character.

19. The system of claim 14, wherein the instructions for obtaining a set of predicted complete queries include instructions for filtering the set of predicted complete queries to remove queries, if any, matching one or more terms in one or more predefined sets of terms.

20. The system of claim 14, wherein the instructions for obtaining a set of predicted complete queries include instructions for:
converting a respective partial search query that includes one or more Korean language characters into a Romanized representation of the respective partial search query
applying a hash function to the Romanized representation of the partial search query to produce a hash value; and
performing a lookup operation using the hash value to obtain the predicted complete queries.

21. The system of claim 14, wherein the instructions for obtaining a set of predicted complete queries include instructions for:
converting a respective partial search query that includes one or more complete Korean language characters and an incomplete Korean language character into a Romanized representation of the respective partial search query;
applying a hash function to the Romanized representation of the respective partial search query to produce a hash value; and
performing a lookup operation using the hash value to obtain the predicted complete queries.

22. The system of claim 14, wherein the received partial search query includes one or more complete Korean language characters and an incomplete Korean language character.

23. A method for building a data structure for processing query information, comprising:
obtaining a set of previously submitted complete first language queries, the complete first language queries previously submitted by a community of users;
obtaining a set of previously submitted complete second language queries, the complete second language queries previously submitted by a community of users;
converting the set of complete first language queries into a set of complete second language queries in Romanized representation; and
storing the sets of complete first language queries and Romanized complete second language queries in one or more query completion data tables;
wherein the one or more query completion data tables form one or more data structures capable of being used to predict both complete first language and second language queries corresponding to either partial first language queries or partial second language queries.

24. The method of claim 23, including filtering the set of previously submitted complete first language queries and the set of previously submitted second language queries to exclude queries matching one or more sets of predefined terms.

25. The method of claim 23, wherein the first language is Korean and the second language is English.

26. A client system, comprising:
one or more central processing units for executing programs; and
memory to store data and to store one or more programs to be executed by the one or more central processing units, the one or more programs including instructions for:
receiving from a search requestor a partial search query;
obtaining a set of predicted complete queries corresponding to the partial search query from a plurality of previously submitted complete queries, the previously submitted complete queries submitted by a community of users, wherein the set of predicted complete queries includes both first language and second language complete search queries and is ordered in accordance with ranking criteria; and
displaying at least a subset of the ordered set to the search requester.

27. The client system of claim 26, wherein the first language is Korean and the second language is English.

28. A computer readable-storage medium storing one or more programs for execution by one or more processors of a respective server system, the one or more programs comprising instructions for:
receiving from a search requestor a partial search query, the search requestor located remotely from the server;
obtaining a set of predicted complete queries corresponding to the partial search query from a plurality of previously submitted complete queries, the previously submitted complete queries submitted by a community of users; the set of predicted complete queries including both first language and second language complete search queries;
ordering the set of predicted complete queries in accordance with ranking criteria; and
conveying at least a subset of the ordered set to the search requester.

29. The computer readable-storage medium of claim 28, wherein the first language is Korean and the second language is English.

30. A computer readable-storage medium storing one or more programs for execution by one or more processors of a respective client device or system, the one or more programs comprising instructions for:
receiving from a search requestor a partial search query;
obtaining a set of predicted complete queries corresponding to the partial search query from a plurality of previously submitted complete queries, the previously submitted complete queries submitted by a community of users, wherein the set of predicted complete queries includes both first language and second language complete search queries and is ordered in accordance with ranking criteria; and
displaying at least a subset of the ordered set to the search requester.

31. The computer readable-storage medium of claim 30, wherein the first language is Korean and the second language is English.
